(19) United States
(12) Patent Application Publication
(10) Pub. No.: US 2017/0003126 A1
(43) Pub. Date: Jan. 5, 2017

(54) SLOPE AND ANGLE FINDER

(71) Applicant: J YEN LIGH, BELLAIRE, TX (US)

(72) Inventor: J YEN LIGH, BELLAIRE, TX (US)

(21) Appl. No.: 14/789,733

(22) Filed: Jul. 1, 2015

(51) Int. Cl. G01C 9/34

(52) U.S. Cl. CPC G01C 9/34

(57) ABSTRACT

A handheld device for finding the angle of a slope of a surface or verifying whether a surface is level or perpendicular which has a housing with a generally planer configuration, two perpendicularly intersecting straight edges, an arcuate slot of at least 120° up to 180° having a concave and a convex side positioned in said housing said concave side facing and opposed to a long axis of the device, a sealed tubular member filed with liquid and having one gas bubble therein, position along the arcuate slot and visible on at least one side of said housing. The tubular member and a plurality of indicia along said housing adjacent to said slot, indicating degrees between 120° up to 180°.

### BACKGROUND OF THE INVENTION

### Field of the Invention

The present invention relates to a handheld device of the genus of the ancient carpenter's level which uses no electrical or complicated mechanical components for finding the angle of a slope of a surface or verifying whether a surface is level or perpendicular. The functioning of the device is intuitive and would require little or no instruction or description. It is a simple device that is used to measure the slope or angle of a surface as it relates to the horizontal or vertical plane.

### SUMMERY OF THE INVENTION

The present invention is a device comprising a housing having planer rectangular configuration, an arcuate slot of at least 120° up to 180° having a concave and a convex side positioned in said housing and opposed to a long axis of the device, said concave side facing said long axis of, a sealed arcuate tubular member filled with liquid and having a gas bubble therein, position along said arcuate slot and visible on at least one side of said housing, said tubular member being calibrated to determine degree points which are marked on the housing and a plurality of indicia along said housing adjacent to said arcuate slot and said tubular member, indicating degrees along of the arcuate tubular member. The arcuate slot may extend through said housing and the indicia may be on both sides of said housing adjacent to said arcuate slot.

### BRIEF DESCRIPTION OF THE DRAWINGS

FIG. 1 is a side elevation of the present invention.

FIG. 2 is cross sectional view along line 2-2 of FIG. 1.

FIG. 3 demonstrates one embodiment of the use of present invention.

FIG. 4 demonstrates a second embodiment of the use of present invention.

FIG. 5 demonstrates a third embodiment of the use of present invention.

FIG. 6 demonstrates a fourth embodiment of the use of present invention.

FIG. 7 demonstrates a fifth embodiment of the use of present invention having two gage components.

FIG. 8 demonstrates a sixth embodiment of the use of present invention having a gage having a 120° range.

### DETAILED DESCRIPTION

In FIG. 1 the housing 201 has sides 203, 204, 211 and 218. Side 204 is parallel with side 211, and side 203 is parallel with side 218. Sides 203 and 218 are perpendicular to both sides 204 and 211, therefore forming either a square or rectangle with four 90 degree corners. Line 222 is parallel with sides 204 and 211. Line 221 is perpendicular to line 222 and sides 204 and 211. The housing 201 has a cutout arc 202 that is between 120 to 180 degrees of an arc of a circle. Lines 209 and 210 define the ends of cutout 202. A cutout of no more than 120 degrees is all that is required, but a cutout of 180 degrees or more may be used if desired. Angles 223 and 224 are equal. A transparent or translucent tube 205 is fixed within the cutout arc 202 in the housing 201. Tube 205 is filled with a liquid 206 preferably of a color for ease of viewing, and sealed with a small air bubble 207 inside the tube. On both sides of the housing 201 along the cutout arc 202 are degree marks 208 which are calibrated between 0 (zero) and the end of the arc, with 0 (zero) along line 221 and increasing to lines 209 and 210. Due to potential space limitations, the size of the housing 201 may affect how many degree marks can be placed. Optional magnetic strips 214, 215, 218, 219, and 220 may be imbedded in housing 201 along sides 203, 204, 218, and 221 respectively.

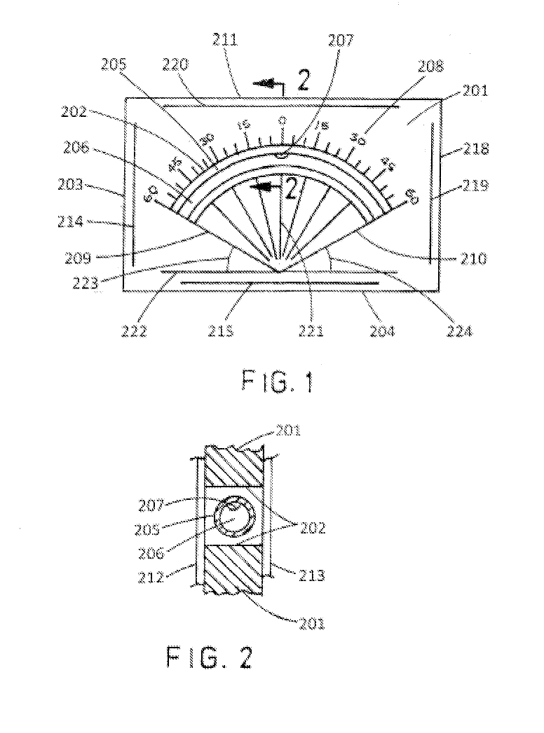

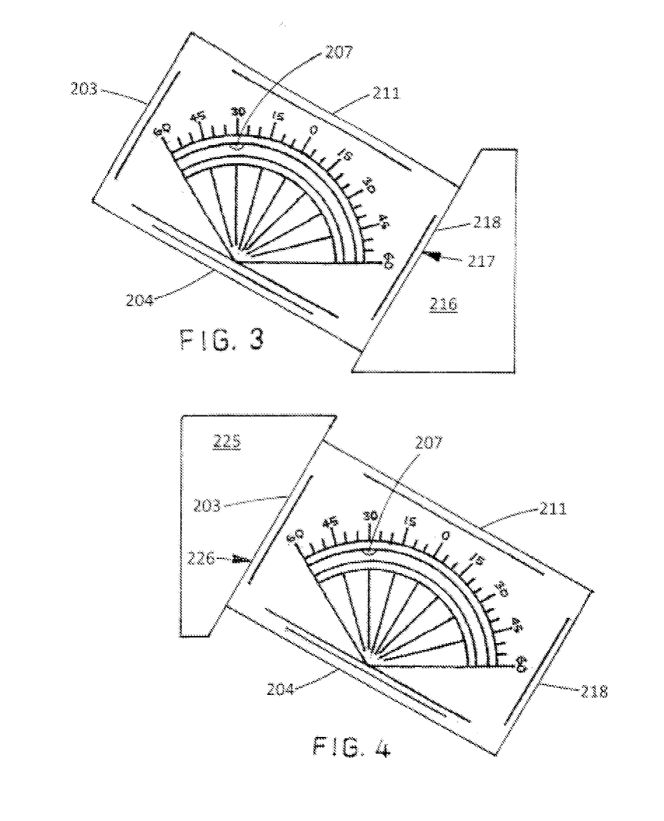

In FIG. 2 components 212 and 213 are optional transparent material fixed to the housing 201 to protect the tube 205.

### Applications of the Invention

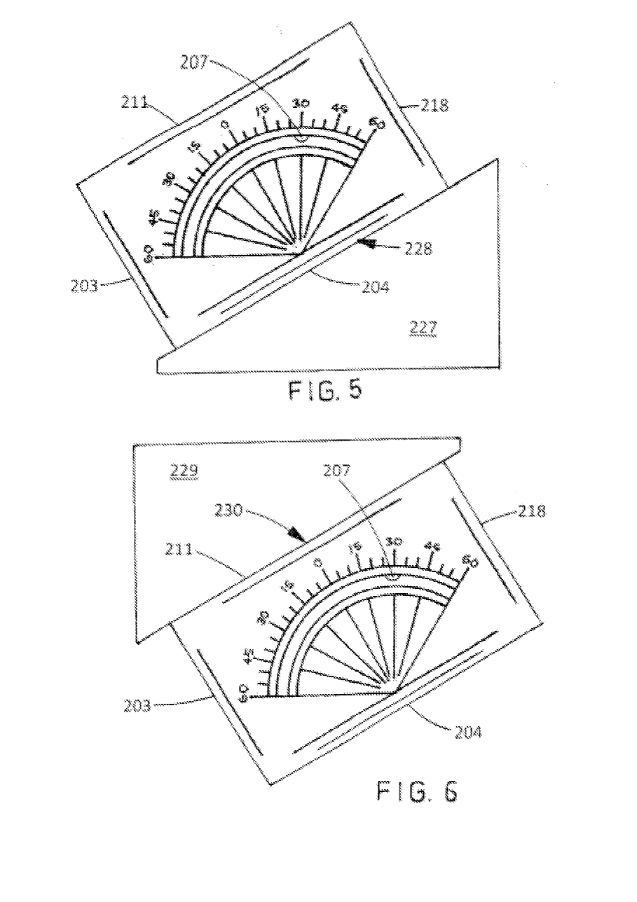

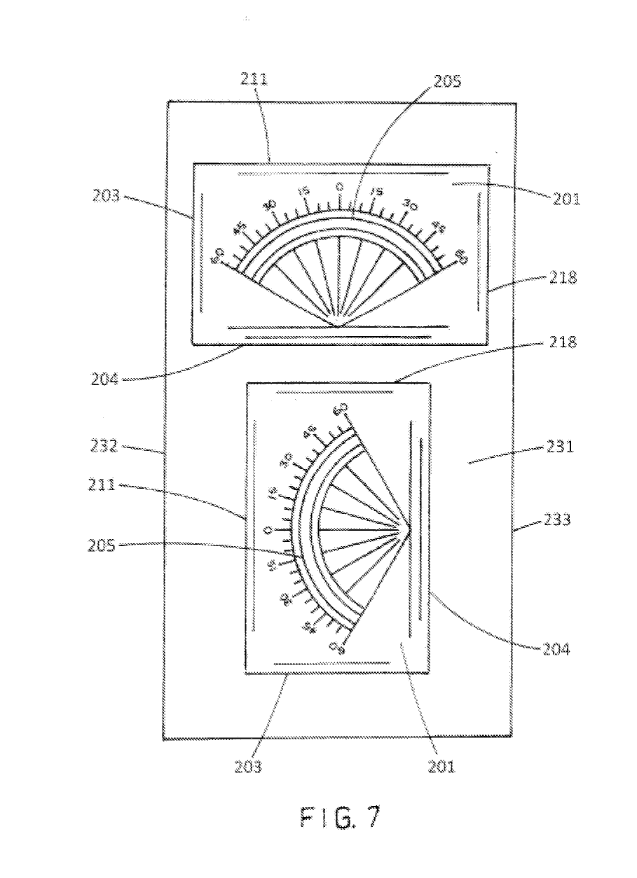

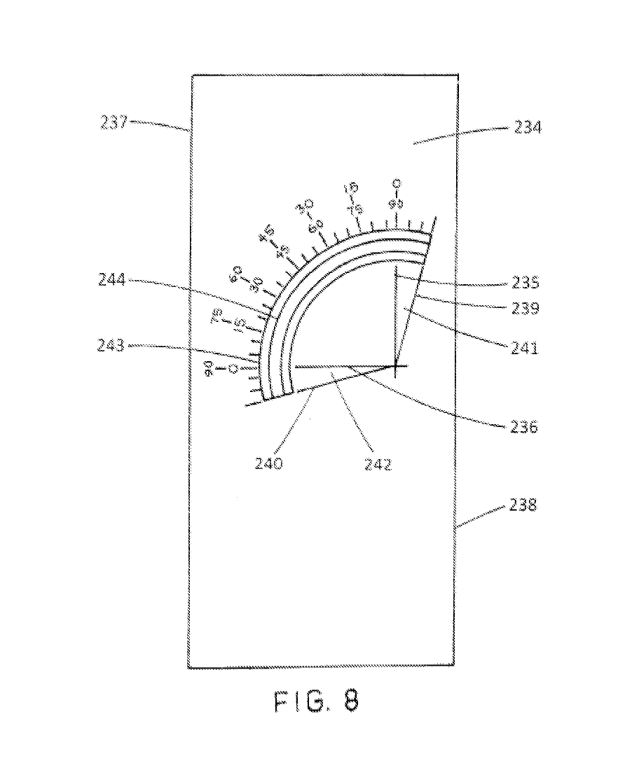

An air bubble in a circular tube filled with a liquid will rise to the highest point along the tube. FIGS. 3, 4, 5 and 6 show typical applications of the invention. In FIG. 3, side 218 is placed against the top side 217 of object 216 to measure the angle. The air bubble 207 indicates the angular deviation of the surface with respect to the vertical plane. In FIG. 7, side 203 is placed against the underside 226 of object 225 to measure the angle. The air bubble 207 indicates the angular deviation of the surface with respect to the vertical plane. In FIG. 8, side 204 is placed against the top side 228 of object 227 to measure the angle. The air bubble 207 indicates the angular deviation of the surface with respect to the horizontal plane. In FIG. 9, side 211 is placed against the underside 230 of object 229 to measure the angle. The air bubble 207 indicates the angular deviation of the surface with respect to the horizontal plane. Sides 203 and 218 are used to measure angles with respect to the vertical plane as shown in FIGS. 3 and 4. Sides 204 and 211 are used to measure angles with respect to the horizontal plane as shown in FIGS. 5 and 6.

FIG. 7 shows another embodiment of the invention. A body 231 has sides 232 and 233 that are parallel to each other. The length of body 231 is by manufacturer's choice. Two housings 201 with its contents are fixed onto body 231 rotated 90 degrees with respect to each other; with one of the housing's sides 203 and 218 parallel to sides 232 and 233 respectively. The other housing's sides 204 and 211 are parallel to sides 233 and 232 respectively. This embodiment will allow an inclined surface to be compared with either the horizontal or vertical planes without additional manipulation of the device. Side 232 is used to measure the underside of an inclined surface while side 233 is used to measure the top side of an inclined surface. The bubble in the upper tube 205 indicates the deviation of the surface with the vertical plane while the bubble in the lower tube 205 indicates the deviation of the surface with the horizontal plane. Both cutouts and degree marks may be viewed from either side of the body 231. If the surface to be measured is 45 degrees from either plane, the bubble 207 in both tubes 205 will be at the 45 degree mark.

FIG. 8 shows another embodiment of the invention. A body 234 has sides 237 and 238 that are parallel to each other. The length of the body is by manufacturer's choice. The body 234 has a cutout that is at least 120 degrees of an arc of a circle, ending at lines 239 and 240. Line 235 is parallel with sides 237 and 238. Line 236 is perpendicular to line 237 and 238. Angles 241 and 242 are equal. A liquid filled tube 244 with an air bubble inside as shown in FIG. 4 is fixed inside the cutout 243. Along the edge of the cutout 243 are degree marks as shown, starting with 0 (zero) along line 236 to 90 degrees along line 235 at the top. Above these degree marks are additional degree marks starting with 0 (zero) along line 235 to 90 degrees along line 236 at the bottom. The degree marks closest to the cutout indicate angular deviations with the horizontal plane while the upper degree marks indicate angular deviations with the vertical plane. Side 238 is used to measure the top side of an inclined surface, and side 237 is used to measure the underside of an inclined surface.

The invention claimed is:

1. A device comprising a housing having planer configuration, two perpendicularly intersecting straight edges,
an arcuate slot of at least 120° up to 180° having a concave and a convex side positioned in said housing and opposed to a long axis of the device, said concave side facing said long axis,
a sealed tubular member filed with liquid and having one gas bubble therein, position along said arcuate slot and visible on at least one side of said housing, said tubular member being calibrated to determine degree points which are marked on the housing and
a plurality of indicia along said housing adjacent to said arcuate slot and said tubular member, indicating degrees along the arcuate tubular member.

2. The device according to claim 1, wherein said arcuate slot extends through said housing.

3. The device according to claim 2, wherein said indicia are on both sides of said housing adjacent to said arcuate slot.

4. The device according to claim 1, wherein said liquid is colored.

5. The device according to claim 1, wherein a magnetic strip is imbedded in said housing.
